(19) United States
(12) Patent Application Publication
(10) Pub. No.: US 2008/0141738 A1
(43) Pub. Date: Jun. 19, 2008

(54) Lock for a locker

(76) Inventor: Hsueh-Liang Chang, Taichung (TW)

Correspondence Address: COOPER & DUNHAM, LLP, 1185 AVENUE OF THE AMERICAS, NEW YORK, NY, 10036, US

(21) Appl. No.: 11/641,487

(22) Filed: Dec. 19, 2006

(51) Int. Cl. E05B 65/44

(52) U.S. Cl. 70/78

(57) ABSTRACT

A lock for a locker has a housing, a front panel, a control locking device, a main locking device, an electrical controller and a power supply device. The main locking device has an operating knob to operate the lock for the locker. Therefore, when the operating knob is turned, the lock is locked or unlocked. Using an operating knob directly formed on the locking device is convenient.

### BACKGROUND OF THE INVENTION

1. Field of the Invention

The present invention relates to a lock, more particularly to a lock for a locker, which can be operated without a key.

2. Description of the Related Art

Lockable lockers are provided in many public places for use by the general public, and most of these lockers require payment for use. A conventional pay locker has a body, a door and a lock. The door is pivotally attached to the body. The lock is conventional, tends to be very complex, is mounted on the door and selectively engages the body, or vice versa, to lock the door and has a coin-activated enabling device, a locking mechanism and a key. A coin is inserted into the coin-activated enabling device to release the coin-activated enabling device. The key is mounted detachably in and locks or unlocks the locking mechanism when the key is rotated in the locking mechanism. When the key is rotated to lock the door after a coin has been inserted into the coin-activated enabling device, the key can be removed from the locking mechanism. However, a user must keep the key to be able to unlock the locker, which is inconvenient.

To overcome the shortcomings, the present invention provides a lock for a locker that is simple and convenient to use to obviate or mitigate the aforementioned problems.

### SUMMARY OF THE INVENTION

The primary objective of the present invention is to provide a lock for a locker that is simple and convenient to use.

A lock in accordance with the present invention for a locker has a housing, a front panel, a control locking device, a main locking device, an electrical controller and a power supply. The main locking device has an operating knob to operate the lock for the locker. Therefore, when the operating knob is turned, the lock is locked or unlocked. The operating knob directly formed on the locking device makes using the lock convenient.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a lock in accordance with the present invention for a locker;

FIG. 2 is a perspective view of the lock in FIG. 1 without a power supply;

FIG. 3 is a side view of the lock in FIG. 1;

FIG. 4 is an operational cross sectional rear view of the lock in FIG. 1 unlocked; and

FIG. 5 is an operational rear view in partial section of the lock in FIG. 1 locked.

### DETAILED DESCRIPTION OF THE INVENTION

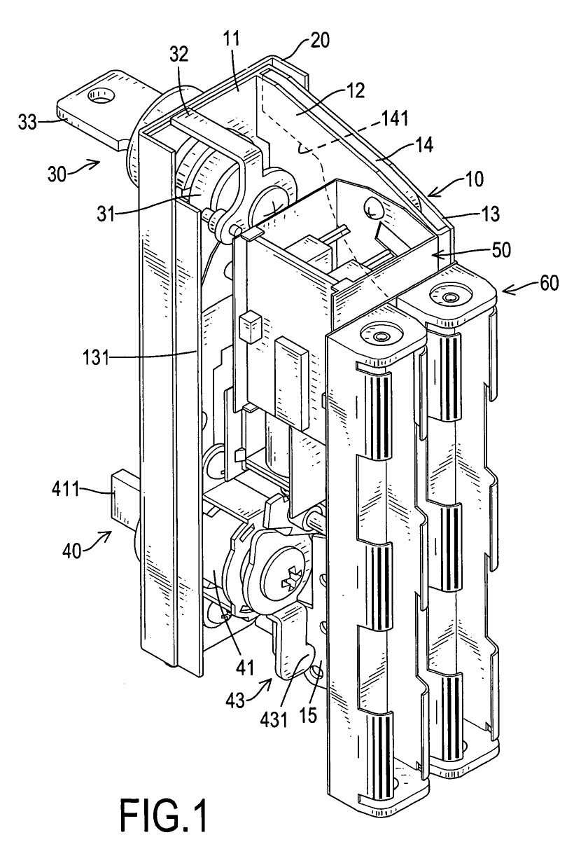

With reference to FIG. 1, a lock in accordance with the present invention for a locker has a housing (10), a front panel (20), a control locking device (30), a main locking device (40), an electrical controller (50) and a power supply (60).

The housing (10) has a bracket (11), a partition (12), a coin passage (14) and a pivoting spade (15).

The bracket (11) has a transverse panel, an elongated wing (13) and a short wing (131). The transverse panel has two mounting holes, a rear surface, two edges and a coin slot. The mounting holes are formed through the transverse panel. The coin slot is formed through the transverse panel. The elongated wing (13) is formed on and protrudes back perpendicular from the rear surface of the transverse panel at one edge and has an inside surface. The short wing (131) is formed on and protrudes back perpendicular from the inside surface of the transverse panel at the other edge parallel to the elongated wing (13).

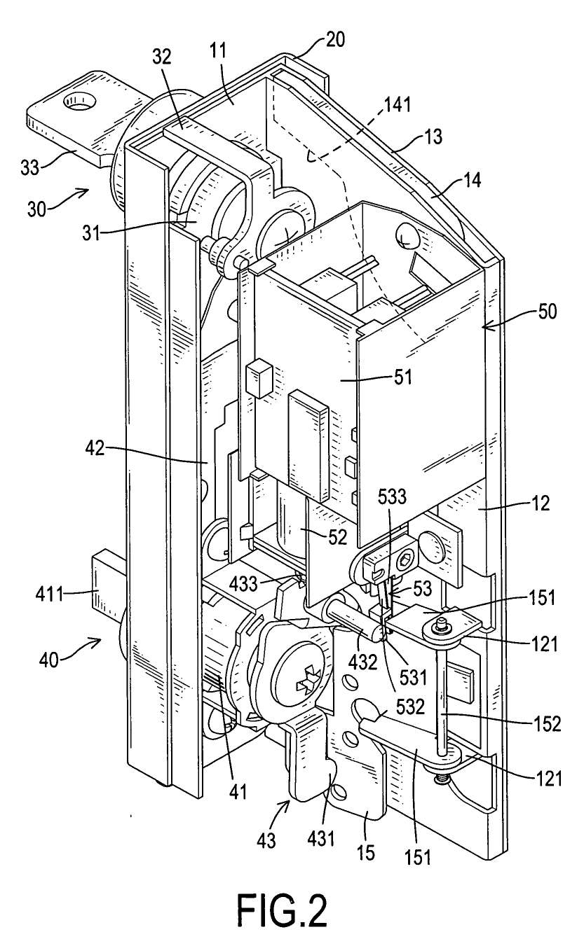

With further reference to FIG. 2, the partition (12) is mounted adjacent to the inside surface of the elongated wing (13), abuts the rear surface of the transverse panel and has an inside surface, a rear edge and two mounting tabs (121). The mounting tabs (121) are formed on and protrude in from the inside surface at the rear edge, and each mounting tab (121) has a central through hole.

The coin passage (14) is formed between the elongated wing (13) and the partition (12), communicates with the coin slot in the bracket (11), receives and guides coins inserted into the coin slot in the bracket (11) and has an inclined bottom edge (141). The inclined bottom edge (141) to allow coins inserted into the coin slot to roll into the lock.

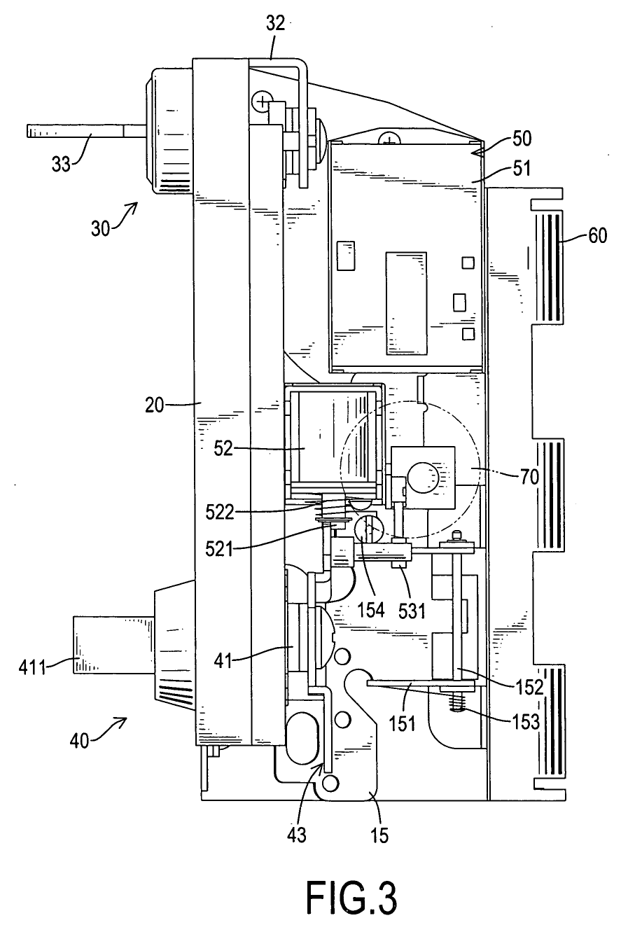

With further reference to FIG. 3, the pivoting spade (15) is connected pivotally to the mounting tabs (121) on the partition (12) and has two pivot arms (151), an pivot rod (152), a torsion spring (153) and a coin stop (154). The pivot arms (151) are formed on and protrude from the pivoting spade (15) and are connected pivotally to the mounting tabs (121). The pivot rod (152) is mounted though the two pivot arms (151) and the mounting tabs (121) and pivotally connects the pivot arms (151) respectively to the mounting tabs (121). The torsion spring (153) is mounted around the pivot rod (152) outside one of the pivot arms (151) and mounting tabs (121) and presses the pivoting spade (15) to close the coin passage (14). The coin stop (154) is formed on and protrudes up from the pivoting spade (15) and is pressed into the coin passage (14) by the torsion spring (153) to block the coin passage (14). Since operation of the bracket (11), the partition (12), the coin passage (14) and the pivoting spade (15) is essentially conventional and is understood by a person with ordinary skill in the relevant art, further description would be redundant and has been omitted.

The front panel (20) is mounted on the transverse panel of the bracket (11) and has a coin slot, a keypad and two mounting holes. The coin slot is formed through the front panel (20) and aligns and communicates with the coin slot in the bracket (11). The keypad is mounted on the front panel (20) to enter and verify a personal identification number (PIN) and activate the lock so the lock can be locked or unlocked. The two mounting holes are formed through the front panel (20) and correspond respectively to the mounting holes through the transverse panel of the bracket (11), and at least one of the mounting holes corresponds to and aligns with the pivoting spade (15).

The control locking device (30) is mounted through a corresponding pair of mounting holes in the transverse panel of the bracket (11) and the front panel (20), overrides other locking features of the lock and may be implemented with a core (31), a lock bracket (32) and a key (33). The core (31) has an inner end, an outer end and a keyhole. The keyhole is formed longitudinally in the lock core (31) through the outer end. The lock bracket (32) holds the core (31) in a pair of aligned mounting holes in the transverse panel of the bracket (11) and the front panel (20), is connected to the inner end of the core (31) and presses against the rear surface of the transverse panel of the bracket (11). The key (33) is held by maintenance or management personnel and is inserted into the keyhole in the core (31) to operate the control locking device (30). Since operation of the control locking device (30) is essentially conventional and is understood by a person with ordinary skill in the relevant art, further description would be redundant and has been omitted.

The main locking device (40) is mounted through the pair of mounting holes in the transverse panel of the bracket (11) and the front panel (20) corresponding to the pivoting spade (15) and has a core (41), a lock bolt (42) and an activating lever (43). The core (41) is mounted through the aligned mounting holes in the transverse panel of the bracket (11) and the front panel (20) and has an inner end, an outer end and an operating knob (411). The operating knob (411) is formed directly on and protrudes longitudinally from the outer end of the core (41) to operate the main locking device (40). The lock bolt (42) is connected to and extends from the core (41) and locks or unlocks a locker door when the core (41) is turned. The activating lever (43) is mounted on the inner end of the core (411) against the pivoting spade (15). When the activating lever (43) presses the coin stop (154), the coin stop (154) moves out of alignment with the coin passage (14). The activating lever (43) may be implemented with a top, a bottom, a contact lever (431), a contact rod (432) and a recess (433). The contact lever (431) extends from the bottom of the activating lever (43) and selectively presses the pivoting spade (15). The contact rod (432) is mounted on the activating lever (43) parallel to the partition (12). The recess (433) is defined in the top of the activating lever (43).

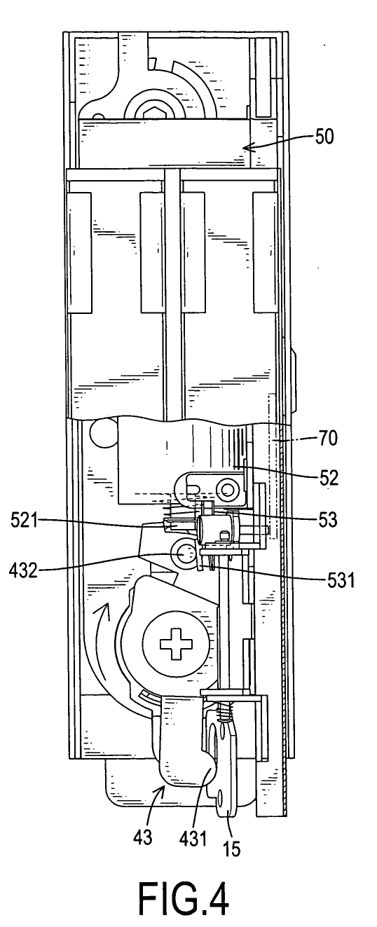

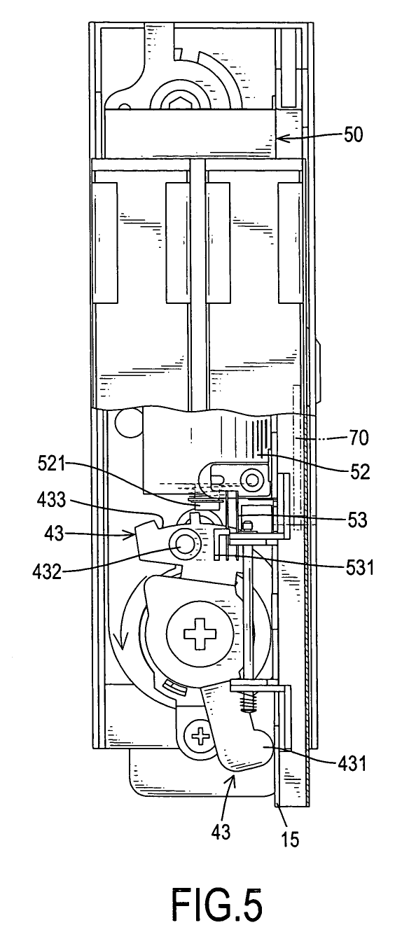

With further reference to FIGS. 4 and 5, the electrical controller (50) enables and disables the lock, is mounted on the inside surface of the partition (12), is connected electrically to the keypad on the front panel (20) and may be implemented with a circuit (51), a connecting device (52) and a conducting device (53). The circuit (51) activates the keypad, receives, verifies and stores the PIN from the keypad and generates activation signals. The connecting device (52) receives an activation signal from the circuit (51), enables the main locking device (40) and has a retractable rod (521) and a spring (522). The retractable rod (521) selectively extends into the recess (433) in the top of the activating lever (43) to keep the activating lever (43) from pivoting and locking or unlocking the lock. The spring (522) is mounted around the retractable rod (521) and provides a retracting bias force to the retractable rod (521). The conducting device (53) is mounted on and protrudes from the connecting device (52), is connected electrically to the circuit (51) and has a stationary contact (533), a resilient contact (532) and an insulated pad (531). The stationary contact (533) is mounted on and protrudes from the connecting device (52) and is aligned with the contact rod (432). The resilient contact (532) is mounted on and protrudes from the connecting device (52) adjacent to the stationary contact (533) between the stationary contact (533) and the contact rod (432) and is selectively pressed against the stationary contact (533) by the contact rod (432) to generate a disabling signal. The disabling signal is transmitted to the circuit (51) in the electrical controller (50) that causes the retractable rod (521) to extend into the recess (433) on the activating lever (43) and disable the main locking device (40). The insulated pad (531) is mounted on the resilient contact (532), faces and aligns with the contact rod (432) and electrically insulates the resilient contact (532) from the contact rod (432).

The power supply device (60) provides electricity to the lock, is mounted on the housing (10), is essentially conventional and is understood by a person with ordinary skill in the relevant art, and further description would be redundant and has been omitted.

The advantage of the lock (1) as described is that the lock is operated by the keypad and the operating knob (411), which is convenient and completely obviates the possibility of a person losing a conventional key.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A lock for a locker, comprising
a housing having
a bracket having
a transverse panel having
two mounting holes being formed through the transverse panel;
a rear surface;
two edges; and
a coin slot being formed through the transverse panel;
an elongated wing being formed on and protruding back perpendicular from the rear surface of the transverse panel at one edge and having an inside surface; and
a short wing being formed on and protruding back perpendicular from the inside surface of the transverse panel at the other edge parallel to the elongated wing;
a partition being mounted adjacent to the inside surface of the elongated wing, abutting the rear surface of the transverse panel and having
an inside surface;
a rear edge; and
two mounting tabs being formed on and protruding in from the inside surface at the rear edge, and each mounting tab having a central through hole;
a coin passage being formed between the elongated wing and the partition, communicating with the coin slot in the bracket, receiving and guiding coins inserted into the coin slot in the bracket and having an inclined bottom edge; and
a pivoting spade being connected pivotally to the mounting tabs on the partition and having
two pivot arms being formed on and protruding from the pivoting spade and being connected pivotally to the mounting tabs;
a pivot rod being mounted though two pivot arms and mounting tabs and pivotally connecting the pivot arms respectively to the mounting tabs;
a torsion spring being mounted around the pivot rod outside one of the pivot arms and mounting tabs and pressing the pivoting spade to close the coin passage; and
a coin stop being formed on and protruding up from the pivoting spade and being pressed into the coin passage by the by the torsion spring;
a front panel being mounted on the transverse panel of the bracket and having
a coin slot being formed through the front panel and aligning and communicating with the coin slot in the bracket;
a keypad being mounted on the front panel to enter and verify a personal identification number (PIN) and activate the lock so the lock can be locked or unlocked; and
two mounting holes being formed through the front panel and corresponding respectively to the mounting holes through the transverse panel of the bracket, and at least one of the mounting hole corresponding to and aligning with the pivoting spade;
a control locking device being mounted through a corresponding pair of mounting holes in the transverse panel of the bracket and the front panel, overriding other locking features of the lock;
a main locking device mounted through the pair of mounting holes in the transverse panel of the bracket and the front panel corresponding to the pivoting spade and having
a core being mounted through the aligned mounting holes in the transverse panel of the bracket and the front panel and having
an inner end,
an outer end, and
an operating knob being formed directly on and protruding longitudinally from the outer end of the core;
a lock bolt being connected to and extending from the core and locking or unlocking a locker door when the core is turned; and
an activating lever mounted on the inner end of the core against the pivoting spade;
an electrical controller enabling and disabling the lock, being mounted on the inside surface of the partition and being connected electrically to the keypad on the front panel; and
a power supply device providing electricity to the lock and being mounted on the housing.

2. The lock as claimed in claim 1, wherein the control locking device is implemented with
a core having
an inner end;
an outer end; and
a keyhole formed longitudinally in the lock core through the outer end;
a lock bracket holding the core in a pair of aligned mounting hole in the transverse panel of the bracket and the front panel, connect to the inner end of the core and pressing against the rear surface of the transverse panel of the bracket; and
a key held by maintenance or management personnel and inserted into the keyhole in the core to operate the control locking device.

3. The lock for a cabinet as claimed in claim 1, wherein
the activating lever of the main locking device is implemented with
a top;
a bottom;
a contact lever extending from the bottom of the activating lever and selectively pressing the pivoting spade;
a contact rod mounted on the activating lever parallel to the partition; and
a recess defined in the top of the activating lever; and
the electrical controller is implemented with
a circuit activating the keypad, receiving, verifying and storing the PIN from the keypad and generating activation signals;
a connecting device receiving an activation signal from the circuit, enabling the main locking device and having
a retractable rod selectively extending into the recess in the top of the activating lever to keep the activating lever from pivoting and locking and unlocking the lock; and
a spring mounted around the retractable rod and providing a retracting bias force to the retractable rod, and
a conducting device mounted on and protruding from the connecting device, connected electrically to the circuit and having
a stationary contact mounted on and protruding from the connecting device and aligned with the contact rod;
a resilient contact mounted on and protruding from the connecting device adjacent to the stationary contact between the stationary contact and the contact rod and selectively pressed against the stationary contact by the contact rod to generate a disabling signal transmitted to the circuit in the electrical controller that causes the retractable rod to extend into the recess on the activating lever and disable the main locking device; and
an insulated pad mounted on the resilient contact, facing and aligning with the contact rod and electrically insulating the resilient contact from the contact rod.

4. The lock for a cabinet as claimed in claim 2, wherein
the activating lever of the main locking device is implemented with
a top;
a bottom;
a contact lever extending from the bottom of the activating lever and selectively pressing the pivoting spade;
a contact rod mounted on the activating lever parallel to the partition; and
a recess defined in the top of the activating lever; and
the electrical controller is implemented with
a circuit activating the keypad, receiving, verifying and storing the PIN from the keypad and generating activation signals;
a connecting device receiving an activation signal from the circuit, enabling the main locking device and having
a retractable rod selectively extending into the recess in the top of the activating lever to keep the activating lever from pivoting and locking and unlocking the lock; and
a spring mounted around the retractable rod and providing a retracting bias force to the retractable rod, and
a conducting device mounted on and protruding from the connecting device, connected electrically to the circuit and having
a stationary contact mounted on and protruding from the connecting device and aligned with the contact rod;
a resilient contact mounted on and protruding from the connecting device adjacent to the stationary contact between the stationary contact and the contact rod and selectively pressed against the stationary contact by the contact rod to generate a disabling signal transmitted to the circuit in the electrical controller that causes the retractable rod to extend into the recess on the activating lever and disable the main locking device; and
an insulated pad mounted on the resilient contact, facing and aligning with the contact rod and electrically insulating the resilient contact from the contact rod.
